(19) United States
(12) Patent Application Publication
(10) Pub. No.: US 2011/0257818 A1
(43) Pub. Date: Oct. 20, 2011

(54) Dynamically Monitoring Airborne Turbulence

(75) Inventors: Matthew W. Ganz, Marina Del Rey, CA (US); Charles B. Spinelli, Bainbridge Island, WA (US)

(73) Assignee: THE BOEING COMPANY, Chicago, IL (US)

(21) Appl. No.: 12/761,774

(22) Filed: Apr. 16, 2010

(51) Int. Cl. G06F 19/00; G01C 21/00

(52) U.S. Cl. 701/14; 701/213

(57) ABSTRACT

A method for monitoring for turbulence. Data is received from a motion sensor system in a portable data processing system in an aircraft while the aircraft is in operation. The portable data processing system is configured to be moved by a single person. A number of pieces of data is identified in the data received from the motion sensor system in which the number of pieces of data indicates a presence of turbulence encountered. Turbulence information is generated using the number of pieces of data. The turbulence information identified is sent to a remote data processing system outside of the aircraft.

### BACKGROUND INFORMATION

1. Field:

The present disclosure relates generally to aircraft and, in particular, to detecting turbulence while an aircraft is in flight. Still more particularly, the present disclosure relates to a method and apparatus to dynamically monitor for turbulence while an aircraft is in flight.

2. Background:

Turbulence in the air occurs when an erratic movement of air masses is present. Oftentimes, the turbulence is referred to as clear air turbulence, because the movement of air occurs in the absence of any visual indications, such as clouds.

Turbulence may occur at different altitudes. For example, turbulence may occur at an altitude of about 23,000 feet to about 39,000 feet around jet streams. Additionally, turbulence may be encountered at other altitudes. For example, turbulence may be encountered at lower altitudes, such as near mountain ranges.

Turbulence is often difficult to detect visually and with currently used radar systems. In some cases, sensors, such as Doppler, light detection and ranging systems, and scintillometers may be used. These types of systems measure turbulence using optical techniques. Additionally, turbulence may be reported by pilots in aircraft reporting that they have encountered turbulence at certain locations and altitudes.

The identification of turbulence is used by pilots and air traffic controllers to reduce undesired conditions during flight. Turbulence may move or shake an aircraft such that passengers and crew find it difficult to walk, baggage may fly out of opened overhead bins, drinks and other items may tip over, and/or other undesirable conditions may occur.

Thus, it would be advantageous to have a method and apparatus which takes into account one or more of the issues discussed above, as well as possibly other issues.

### SUMMARY

In one advantageous embodiment, an apparatus comprises a portable data processing system and program code. The portable data processing system comprises a portable housing configured to be moved by a single person, and a processor unit associated with the portable housing. The portable data processing system comprises a motion sensor system associated with the portable housing. The motion sensor system is configured to generate data about movement detected for the portable data processing system. The portable data processing system also comprises a wireless communications unit associated with the portable data processing system and a storage device. The program code is stored on the storage device. The processor unit is configured to run the program code to receive the data from the motion sensor system. The processor unit is configured to run the program code to identify a number of pieces of data in the data received from the motion sensor system in which the number of pieces of data indicates a presence of turbulence encountered by an aircraft in which the portable data processing system is located. The processor unit is also configured to run the program code to generate turbulence information using the number of pieces of data and send the turbulence information identified to a remote data processing system outside of the aircraft.

In another advantageous embodiment, a method is present for monitoring for turbulence. Data is received from a motion sensor system in a portable data processing system in an aircraft while the aircraft is in operation. The portable data processing system is configured to be moved by a single person. A number of pieces of data is identified in the data received from the motion sensor system in which the number of pieces of data indicates a presence of turbulence encountered. Turbulence information is generated using the number of pieces of data. The turbulence information identified is sent to a remote data processing system outside of the aircraft.

In yet another advantageous embodiment, a computer program product for monitoring turbulence comprises a computer recordable storage medium and program code. The program code is stored on the computer recordable storage medium. Program code is present for receiving data from a motion sensor system in a portable data processing system in an aircraft while the aircraft is in operation. The portable data processing system is configured to be moved by a single person. Program code is present for identifying a number of pieces of data in the data received from the motion sensor system in which the number of pieces of data indicates a presence of turbulence encountered. Program code is present for generating turbulence information using the number of pieces of data and for sending the turbulence information identified to a remote data processing system outside of the aircraft.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives, and advantages thereof, will best be understood by reference to the following detailed description of an advantageous embodiment of the present disclosure when read in conjunction with the accompanying drawings, wherein:

FIG. 1 is an illustration of a turbulence monitoring environment in accordance with an advantageous embodiment;

FIG. 2 is an illustration of a turbulence monitoring environment in accordance with an advantageous embodiment;

FIG. 3 is an illustration of a data processing system in accordance with an advantageous embodiment;

FIG. 4 is an illustration of turbulence information in accordance with an advantageous embodiment;

FIG. 5 is an illustration of processed turbulence information in accordance with an advantageous embodiment;

FIG. 6 is an illustration of turbulence information in accordance with an advantageous embodiment;

FIG. 7 is an illustration of turbulence information in accordance with an advantageous embodiment;

FIG. 8 is an illustration of turbulence information in accordance with an advantageous embodiment;

FIG. 9 is an illustration of turbulence information displayed on a data processing system in accordance with an advantageous embodiment;

FIG. 10 is an illustration of a flowchart of a process for monitoring for air turbulence;

FIG. 11 is an illustration of a flowchart of a process for processing turbulence information in accordance with an advantageous embodiment;

FIG. 12 is an illustration of a flowchart of a process for processing turbulence information in accordance with an advantageous embodiment; and

FIG. 13 is an illustration of a flowchart of a process for generating a turbulence alert in accordance with an advantageous embodiment.

### DETAILED DESCRIPTION

The advantageous embodiments recognize and take into account a number of different considerations. For example, the different advantageous embodiments recognize and take into account that the identification of turbulence can be made in a number of different ways. For example, turbulence can be made through reports made by pilots in aircraft encountering turbulence. Additionally, weather forecasts also are used to predict when turbulence may occur. Accelerometers may be associated or integrated into the structure of the aircraft to identify turbulence.

The different advantageous embodiments recognize and take into account that the reporting of turbulence by pilots may not provide information on turbulence as frequently as desired. This type of reporting requires a pilot to verbally report the encountering of turbulence by the aircraft each time the aircraft encounters turbulence. Further, this type of reporting may not provide the desired amount of accuracy in determining the level of severity of turbulence that has been encountered.

The different advantageous embodiments recognize and take into account that the reports made by pilots only relate to a specific region and time of occurrence. Typically, the location and the magnitude of the turbulence may be less precise than desired.

The different advantageous embodiments recognize and take into account that weather forecasts may provide a probability that turbulence occurs. Weather forecasts are often not as accurate as desired with respect to time, magnitude, and location of turbulence. Further, these types of forecasts may result in false negative or false positive warnings.

As a result, the different advantageous embodiments recognize and take into account that turbulence may be encountered when turbulence is not expected if a pilot relies on the weather forecasts. Additionally, passengers may be inconvenienced by false positive warnings. Passengers may be restricted to their seats when such restriction is unnecessary.

The different advantageous embodiments also recognize and take into account that using accelerometers in the structure of the aircraft provides continuous monitoring and a more precise way to identify the severity of turbulence. The different advantageous embodiments recognize and take into account that the use of accelerometers to generate information used by the network of the aircraft requires testing and certification. As a result, installing accelerometers in aircraft has installation costs, testing costs, delay costs, and/or certification costs. Thus, this type of installation may be more costly and/or time consuming than desired.

Thus, the different advantageous embodiments provide a method and apparatus for monitoring for air turbulence. A number of advantageous embodiments comprise an apparatus that has a portable data processing system and program code used by the portable data processing system.

The portable data processing system comprises a portable housing, a processor unit, a motion sensor system, a wireless communications unit, and a storage device. The processor unit, the motion sensor system, the wireless communications unit, and the storage device are all associated with the portable housing.

A first component may be considered to be associated with a second component by being secured to the second component, bonded to the second component, fastened to the second component, and/or connected to the second component in some other suitable manner. The first component also may be connected to the second component by using a third component. The first component may also be considered to be associated with the second component by being formed as part of and/or an extension of the second component.

The processor unit is configured to run the program code to receive data from the motion sensor system and identify a number of pieces of data in the data received from the motion sensor system. The number of pieces of data indicates a presence of turbulence encountered by an aircraft in which the portable data processing system is located. Further, the processor unit is configured to run the program code to generate turbulence information using the number of pieces of data and send the turbulence information identified to a remote data processing system outside of the aircraft.

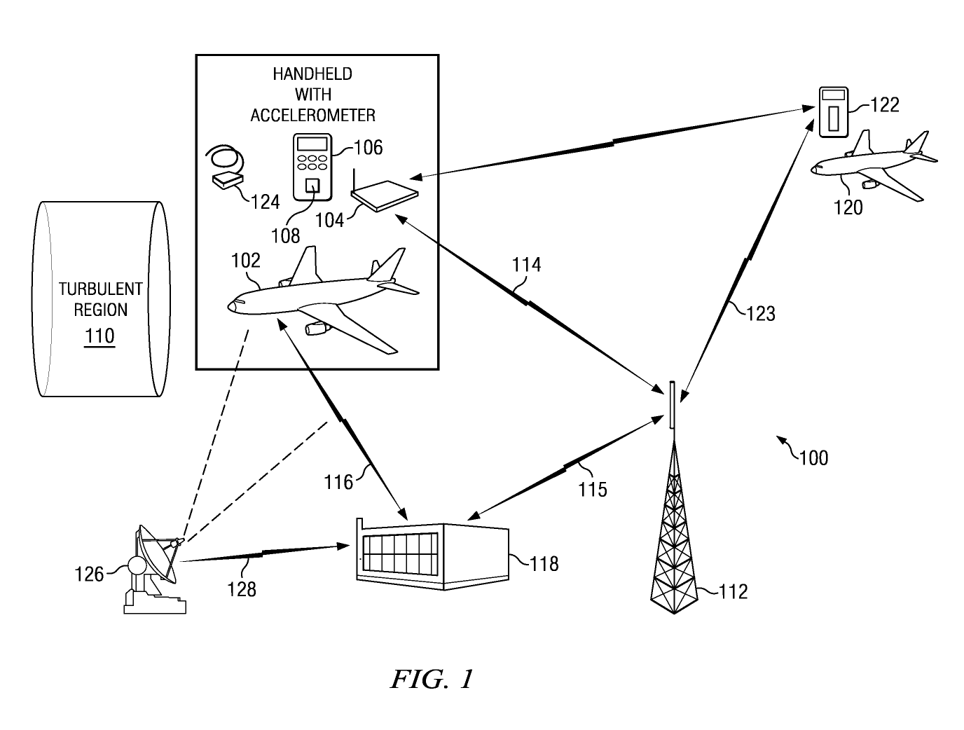

With reference now to FIG. 1, an illustration of a turbulence monitoring environment is depicted in accordance with an advantageous embodiment. In this example, turbulence monitoring environment 100 includes aircraft 102. Aircraft 102 has wireless network 104 inside of aircraft 102. Additionally, handheld data processing system 106 is present inside of aircraft 102.

As depicted, handheld data processing system 106 includes accelerometer 108. Accelerometer 108 is configured to detect movement of handheld data processing system 106. Handheld data processing system 106, in these examples, is placed on or secured to the interior of aircraft 102. Although handheld data processing system 106 may be held by a person, detection of turbulence in turbulent region 110 may be more accurately detected and measured if handheld data processing system 106 is connected to or somehow secured to the interior of aircraft 102.

For example, handheld data processing system 106 may be placed on a table, a cart, in a drawer, or some other location inside of aircraft 102. As another example, handheld data processing system 106 may be secured to a monument or other structure in the interior of the aircraft using a strap, a hook-and-loop fastener, and/or other suitable types of fastening systems.

In these illustrative examples, accelerometer 108 generates data in response to detecting motion of handheld data processing system 106. In these illustrative examples, handheld data processing system 106 identifies information from the data. This information may be, for example, turbulence information about turbulent region 110. Handheld data processing system 106 transmits the information to wireless network 104.

This data may then be sent to a number of different locations. For example, the data may be sent to transmitter and receiver 112 over wireless communications link 114. In turn, transmitter and receiver 112 may send the information to ground station 118 or aircraft 120 over wireless communications link 115. In some illustrative embodiments, ground station 118 may directly receive the information from wireless network 104 through wireless communications link 116.

Ground station 118 processes the information from handheld data processing system 106 to generate processed information. In some illustrative examples, ground station 118 may use information from other sources to process the information from handheld data processing system 106. These other sources may include, for example, without limitation, databases at ground station 118, databases that may be accessed by ground station 118, and/or other suitable sources of information.

In another illustrative example, ground station 118 may retrieve information from a database using a wireless communications link. This information may include a type for aircraft 102 and a weight of aircraft 102. This information may be used with the information received from handheld data processing system 106 to calculate an eddy dissipation rate (EDR). The eddy dissipation rate may be used to classify the turbulence in turbulent region 110. The classification for the turbulence is part of the processed information generated at ground station 118.

This processed information may then be distributed for use. For example, ground station 118 may send the processed information to handheld data processing system 122 in aircraft 120 using wireless communications link 123.

Ground station 118 may identify aircraft 120 as an aircraft to receive information based on the location of aircraft 102 and the location and heading of aircraft 120. If aircraft 120 is headed towards turbulent region 110, ground station 118 sends the information to aircraft 120.

The location of aircraft 102 may be identified in a number of different ways. The location of aircraft 102 may be identified using, for example, global positioning system unit 124. Global positioning system unit 124 may be associated with handheld data processing system 106 in aircraft 102.

For example, global positioning system unit 124 may be part of handheld data processing system 106. An antenna may be attached to a window or other location where satellite signals may be received by global positioning system unit 124. In other illustrative examples, global positioning system unit 124 may be a separate device in communication with handheld data processing system 106.

In yet another illustrative example, radar system 126 may identify the location of aircraft 102. This location may then be sent to ground station 118 over communications link 128.

In these examples, information sent to aircraft 120 may take various forms. The information may include information received from handheld data processing system 106 and/or other information. For example, ground station 118 may create a report or map that is sent to handheld data processing system 122 in aircraft 120. The information may include a warning and an amount of time in which aircraft 120 is predicted to encounter turbulent region 110. In other illustrative examples, the information sent to handheld data processing system 122 may include a map of turbulence in an area around aircraft 120.

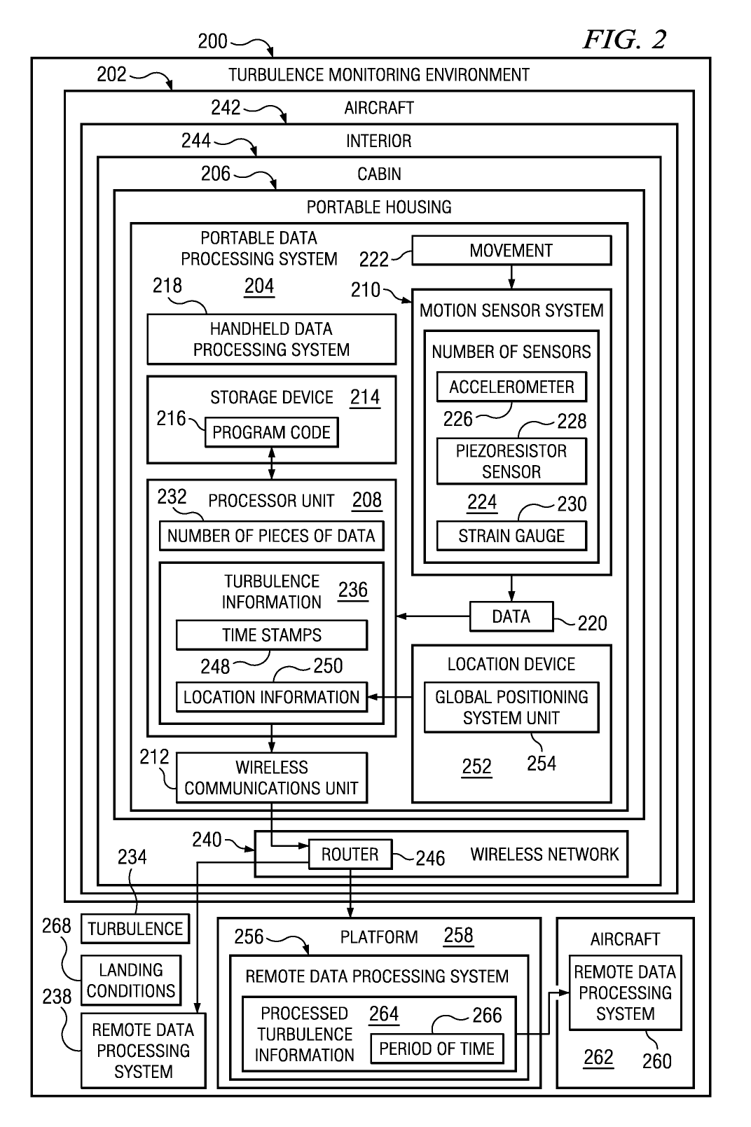

With reference now to FIG. 2, an illustration of a turbulence monitoring environment is depicted in accordance with an advantageous embodiment. Turbulence monitoring environment 100 in FIG. 1 is an example of one implementation for turbulence monitoring environment 200 in FIG. 2.

In this illustrative example, turbulence monitoring environment 200 includes aircraft 202 and portable data processing system 204. In these illustrative examples, portable data processing system 204 is configured for use inside of aircraft 202.

Portable data processing system 204 comprises portable housing 206, processor unit 208, motion sensor system 210, wireless communications unit 212, and storage device 214. Portable data processing system 204 is in portable housing 206. Processor unit 208, motion sensor system 210, wireless communications unit 212, and storage device 214 are associated with portable housing 206 in these examples. Of course, portable data processing system 204 may include other components in addition to or in place of the ones illustrated herein.

Portable housing 206 is configured to be moved by a single person. In other words, portable data processing system 204 in portable housing 206 may be moved by one person without needing help from another person. In addition, the person does not need to use equipment to move portable data processing system 204. For example, a single person may pick up portable housing 206 with their hands and move portable housing 206.

In some illustrative examples, portable data processing system 204 takes the form of handheld data processing system 218. Handheld data processing system 218 has portable housing 206 that is designed to, for example, allow a person to hold handheld data processing system 218 in a single hand.

In these examples, motion sensor system 210 includes number of sensors 224. Number of sensors 224 may include, for example, at least one of accelerometer 226, piezoresistor sensor 228, strain gauge 230, and/or other suitable types of sensors.

As used herein, the phrase “at least one of”, when used with a list of items, means that different combinations of one or more of the listed items may be used and only one of each item in the list may be needed. For example, “at least one of item A, item B, and item C” may include, for example, without limitation, item A or item A and item B. This example also may include item A, item B, and item C, or item B and item C. In other examples, “at least one of” may be, for example, without limitation, two of item A, one of item B, and 10 of item C; four of item B and seven of item C; and other suitable combinations.

In these illustrative examples, number of sensors 224 in motion sensor system 210 is configured to generate data 220 about movement 222 detected for portable data processing system 204.

In the illustrative examples, program code 216 is located in storage device 214. Processor unit 208 runs program code 216 to receive data 220 from motion sensor system 210. Further, processor unit 208 runs program code 216 to identify number of pieces of data 232 in data 220 received from motion sensor system 210. Number of pieces of data 232 indicates a presence of turbulence 234 encountered by aircraft 202. Further, processor unit 208 runs program code 216 to generate turbulence information 236 using number of pieces of data 232. Processor unit 208 sends turbulence information 236 to remote data processing system 238 outside of aircraft 202.

In these illustrative examples, turbulence information 236 is transmitted to wireless network 240 using wireless communications unit 212 in portable data processing system 204. For example, turbulence information 236 may be sent to remote data processing system 238 over the Internet using wireless network 240.

Wireless network 240 is a wireless network located in interior 242 of aircraft 202. For example, wireless network 240 may be present in cabin 244 of aircraft 202.

Wireless network 240 may include, for example, router 246. Router 246 is configured to receive turbulence information 236 from portable data processing system 204. Router 246 is configured to send turbulence information 236 to remote data processing system 238.

Wireless network 240 may be implemented using currently available wireless networks in aircraft. The service in these wireless networks may be provided through a number of different providers. For example, Aircell provides wireless networks and Internet access to passengers in aircraft. This type of wireless network may be used to implement wireless network 240 in these examples.

In these illustrative examples, portable data processing system 204 is placed on or secured to interior 242 of aircraft 202. This type of placement of portable data processing system 204 is used instead of having a person carry portable data processing system 204 during operation of portable data processing system 204 to detect movement 222.

In the different illustrative examples, turbulence information 236 may take a number of different forms. For example, without limitation, turbulence information 236 may comprise number of pieces of data 232. In other examples, turbulence information 236 also may include time stamps 248 and/or location information 250. Time stamps 248 identify the time when number of pieces of data 232 was generated by motion sensor system 210. Location information 250 identifies a location of aircraft 202 when number of pieces of data 232 was generated by motion sensor system 210.

Location information 250 may include a location of aircraft 202 in three-dimensional space. For example, longitude and latitude may be present in location information 250. Altitude may also be present in location information 250. Altitude provides a height of aircraft 202.

Location information 250 may be generated using location device 252. Location device 252 is associated with portable data processing system 204. Location device 252 may be connected to or integrated as part of portable data processing system 204.

In these examples, location device 252 may be global positioning system unit 254. When location device 252 takes the form of global positioning system unit 254, an antenna may be attached to a window or other location to allow global positioning system unit 254 to receive satellite signals. In other illustrative examples, location information 250 may be received from other computer systems or networks on aircraft 202, depending upon the particular implementation.

Turbulence information 236 may be sent to remote data processing system 256 at platform 258. Platform 258 may be a ground platform, such as an air traffic control station, or some other location. In other illustrative examples, turbulence information 236 may be sent to another location, such as remote data processing system 260 in aircraft 262. In these illustrative examples, remote data processing system 256 may process turbulence information 236 to form processed turbulence information 264. Remote data processing system 256 then sends processed turbulence information 264 to remote data processing system 260 in aircraft 262.

In these illustrative examples, processed turbulence information 264 may take a number of different forms. For example, without limitation, processed turbulence information 264 may be a map containing an identification of turbulent regions or other information. In addition, processed turbulence information 264 may be merely an indication that turbulence 234 may be encountered by aircraft 262 within period of time 266.

The illustration of turbulence monitoring environment 200 in FIG. 2 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some illustrative examples, portable data processing system 204 may be used to detect other events other than turbulence 234. For example, without limitation, portable data processing system 204 may use data 220 to detect landing conditions 268. Data 220 may be generated when motion sensor system 210 detects movement of aircraft 202 as aircraft 202 lands on a runway. This information may be used to determine whether maintenance may be needed for the landing gear or other systems within aircraft 202. Further, landing conditions 268 also may be used to identify whether changes in landing procedures are needed for other aircraft landing on the same runway.

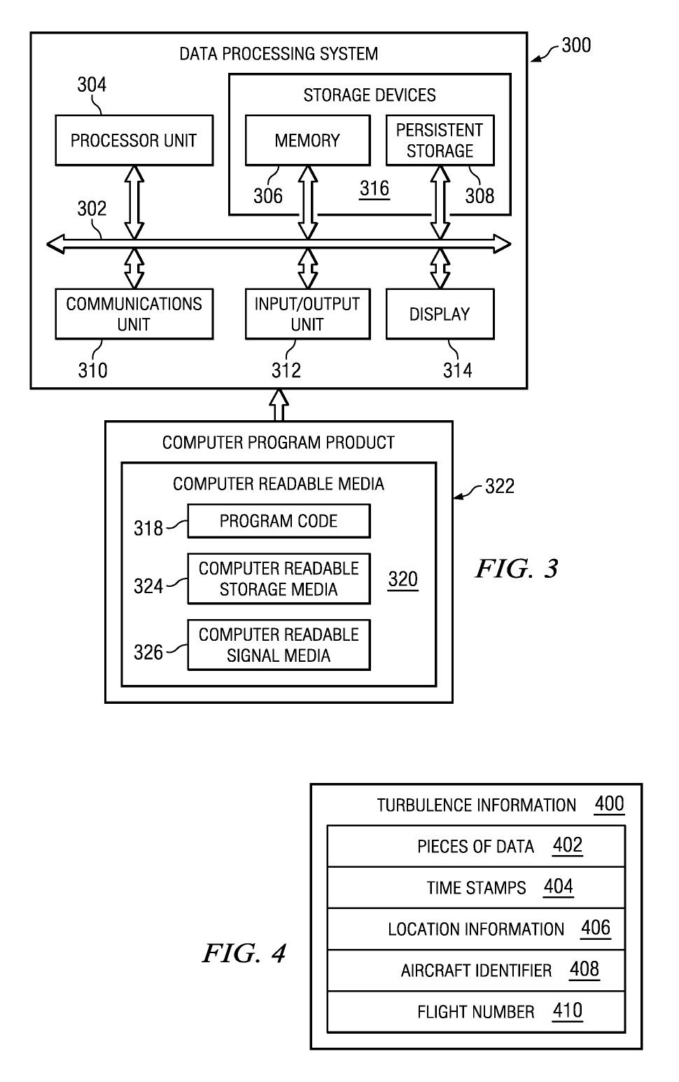

Turning now to FIG. 3, an illustration of a data processing system is depicted in accordance with an advantageous embodiment. Data processing system 300 may be used to implement different components in FIGS. 1 and 2. For example, data processing system 300 may be used to implement handheld data processing system 106, a computer at ground station 118, and/or handheld data processing system 122 in FIG. 1. As another example, data processing system 300 may be used to implement portable data processing system 204, remote data processing system 238, remote data processing system 256, and/or remote data processing system 260 in FIG. 2.

In this illustrative example, data processing system 300 includes communications fabric 302, which provides communications between processor unit 304, memory 306, persistent storage 308, communications unit 310, input/output (I/O) unit 312, and display 314.

Processor unit 304 processes instructions for software that may be loaded into memory 306. Processor unit 304 may be a set of one or more processors or may be a multi-processor core, depending on the particular implementation. Further, processor unit 304 may be implemented using one or more heterogeneous processor systems, in which a main processor is present with secondary processors on a single chip. As another illustrative example, processor unit 304 may be a symmetric multi-processor system containing multiple processors of the same type.

Memory 306 and persistent storage 308 are examples of storage devices 316. A storage device is any piece of hardware that is capable of storing information, such as, for example, without limitation, data, program code in functional form, and/or other suitable information either on a temporary basis and/or a permanent basis. Memory 306, in these examples, may be, for example, a random access memory or any other suitable volatile or non-volatile storage device.

Persistent storage 308 may take various forms, depending on the particular implementation. For example, persistent storage 308 may contain one or more components or devices. For example, persistent storage 308 may be a hard drive, a flash memory, a rewritable optical disk, a rewritable magnetic tape, or some combination of the above. The media used by persistent storage 308 may be removable. For example, a removable hard drive may be used for persistent storage 308.

Communications unit 310, in these examples, provides for communication with other data processing systems or devices. In these examples, communications unit 310 is a network interface card. Communications unit 310 may provide communications through the use of either or both physical and wireless communications links.

Input/output unit 312 allows for the input and output of data with other devices that may be connected to data processing system 300. For example, input/output unit 312 may provide a connection for user input through a keyboard, a mouse, and/or some other suitable input device. Further, input/output unit 312 may send output to a printer. Display 314 provides a mechanism to display information to a user.

Instructions for the operating system, applications, and/or programs may be located in storage devices 316, which are in communication with processor unit 304 through communications fabric 302. In these illustrative examples, the instructions are in a functional form on persistent storage 308. These instructions may be loaded into memory 306 for execution by processor unit 304. The processes of the different embodiments may be performed by processor unit 304 using computer implemented instructions, which may be located in a memory, such as memory 306.

These instructions are referred to as program code, computer usable program code, or computer readable program code that may be read and executed by a processor in processor unit 304. The program code, in the different embodiments, may be embodied on different physical or computer readable storage media, such as memory 306 or persistent storage 308.

Program code 318 is located in a functional form on computer readable media 320 that is selectively removable and may be loaded onto or transferred to data processing system 300 for execution by processor unit 304. Program code 318 and computer readable media 320 form computer program product 322. In one example, computer readable media 320 may be computer readable storage media 324 or computer readable signal media 326.

Computer readable storage media 324 may include, for example, an optical or magnetic disk that is inserted or placed into a drive or other device that is part of persistent storage 308 for transfer onto a storage device, such as a hard drive, that is part of persistent storage 308. Computer readable storage media 324 also may take the form of a persistent storage, such as a hard drive, a thumb drive, or a flash memory that is connected to data processing system 300. In some instances, computer readable storage media 324 may not be removable from data processing system 300.

Alternatively, program code 318 may be transferred to data processing system 300 using computer readable signal media 326. Computer readable signal media 326 may be, for example, a propagated data signal containing program code 318. For example, computer readable signal media 326 may be an electromagnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples.

In some advantageous embodiments, program code 318 may be downloaded over a network to persistent storage 308 from another device or data processing system through computer readable signal media 326 for use within data processing system 300. For instance, program code stored in a computer readable storage media in a server data processing system may be downloaded over a network from the server to data processing system 300. The data processing system providing program code 318 may be a server computer, a client computer, or some other device capable of storing and transmitting program code 318.

The different components illustrated for data processing system 300 are not meant to provide architectural limitations to the manner in which different embodiments may be implemented. The different advantageous embodiments may be implemented in a data processing system including components in addition to or in place of those illustrated for data processing system 300.

Other components shown in FIG. 3 can be varied from the illustrative examples shown. The different embodiments may be implemented using any hardware device or system capable of executing program code. As one example, data processing system 300 may include organic components integrated with inorganic components and/or may be comprised entirely of organic components excluding a human being. For example, a storage device may be comprised of an organic semiconductor.

As another example, a storage device in data processing system 300 is any hardware apparatus that may store data. Memory 306, persistent storage 308, and computer readable media 320 are examples of storage devices in a tangible form.

In another example, a bus system may be used to implement communications fabric 302 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 306 or a cache, such as found in an interface and memory controller hub that may be present in communications fabric 302.

With reference now to FIG. 4, an illustration of turbulence information is depicted in accordance with an advantageous embodiment. In this example, turbulence information 400 is one example of turbulence information 236 in FIG. 2.

As depicted, turbulence information 400 includes pieces of data 402, time stamps 404, location information 406, aircraft identifier 408, and flight number 410.

Pieces of data 402 are portions of the data generated by motion sensor system 210 in FIG. 2 that have been identified as indicating the presence of turbulence. Time stamps 404 may be associated with pieces of data 402 to indicate when pieces of data 402 were generated. Location information 406 identifies the locations of the aircraft when pieces of data 402 are generated.

Aircraft identifier 408 identifies the particular aircraft. This identifier may be some unique number, such as a tail number for the aircraft. Of course, any other type of identifier may be used. Flight number 410 identifies the flight of the aircraft.

Of course, the illustration of turbulence information 400 is only intended as one example of the type of information that may be generated. Turbulence information 400 is sent to a ground station, which may process turbulence information 400. The processing of turbulence information 400 may involve the identification of other aircraft or platforms that should receive turbulence information 400. In other words, turbulence information 400 may only be re-routed without any changes as part of the processing of turbulence information 400. In other illustrative examples, turbulence information 400 may be modified, changed, or replaced during processing.

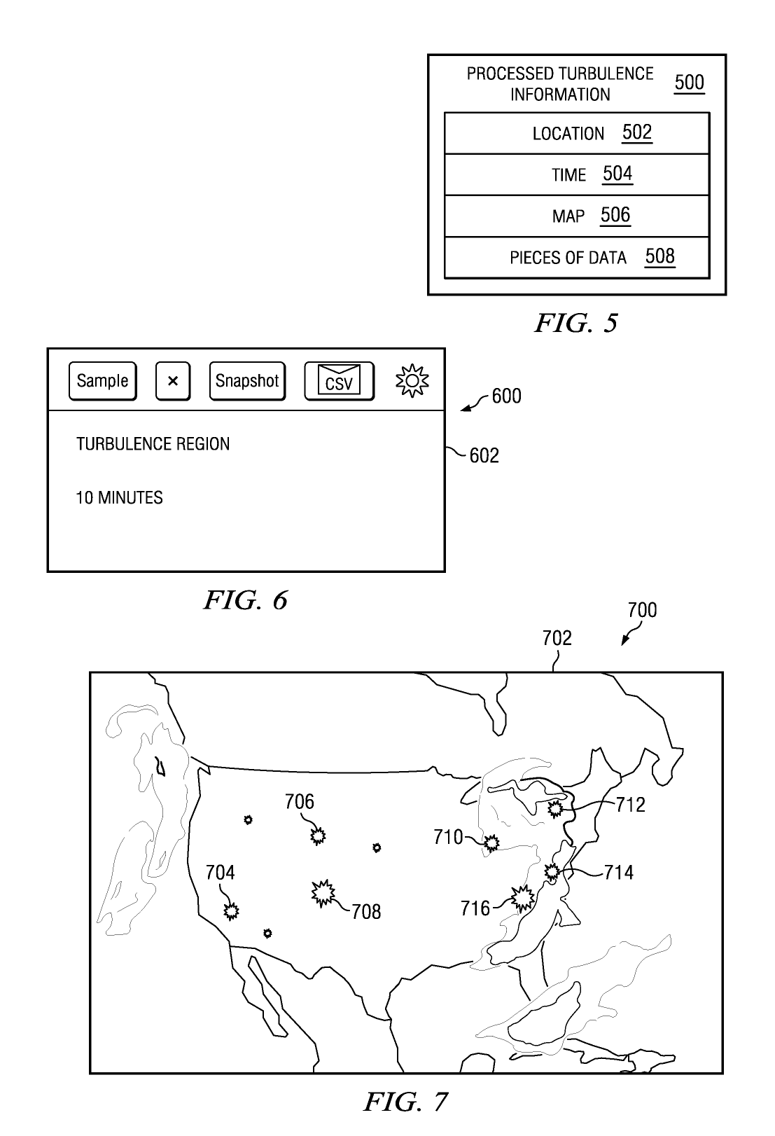

With reference now to FIG. 5, an illustration of processed turbulence information is depicted in accordance with an advantageous embodiment. In this illustrative example, processed turbulence information 500 is an example of processed turbulence information 264 in FIG. 2.

As depicted, processed turbulence information 500 includes location 502, time 504, map 506, and pieces of data 508. Location 502 identifies a location of the turbulence. This location may identify a region of airspace in which turbulence has been detected. Time 504 may indicate a period of time at which the aircraft receiving processed turbulence information 500 will encounter turbulence.

Map 506 includes a map with identifications of turbulence in different regions of the map. Pieces of data 508 include data identified as indicating turbulence. Pieces of data 508 are generated by the portable data processing system detecting the turbulence.

In these illustrative examples, processed turbulence information 500 may, in some examples, include only location 502 and time 504. Processed turbulence information 500 may, in some cases, include map 506 and pieces of data 508 without location 502 and time 504.

With reference now to FIG. 6, an illustration of turbulence information is depicted in accordance with an advantageous embodiment. In this example, turbulence information 600 is presented on display 602.

In this example, turbulence information 600 is an example of turbulence information 236 that may be generated using number of pieces of data 232 in FIG. 2. In this example, turbulence information 600 is displayed on a remote data processing system, such as remote data processing system 260 in aircraft 262 in FIG. 2. Turbulence information 600 indicates that a turbulence region will be reached by the aircraft in 10 minutes.

With reference now to FIG. 7, another example of turbulence information is depicted in accordance with an advantageous embodiment. In these illustrative examples, processed turbulence information 700 is an example of processed turbulence information 264 in FIG. 2. Processed turbulence information 700 may be generated by remote data processing system 260 in FIG. 2 in these depicted examples.

Processed turbulence information 700 is generated from receiving turbulence information from multiple portable data processing systems on different aircraft. In this example, processed turbulence information 700 indicates turbulence is present in regions 704, 706, 708, 710, 712, 714, and 716. In this illustrative example, a user may select one of these regions to display additional turbulence information. An example of the information that may be displayed is depicted in the figure below.

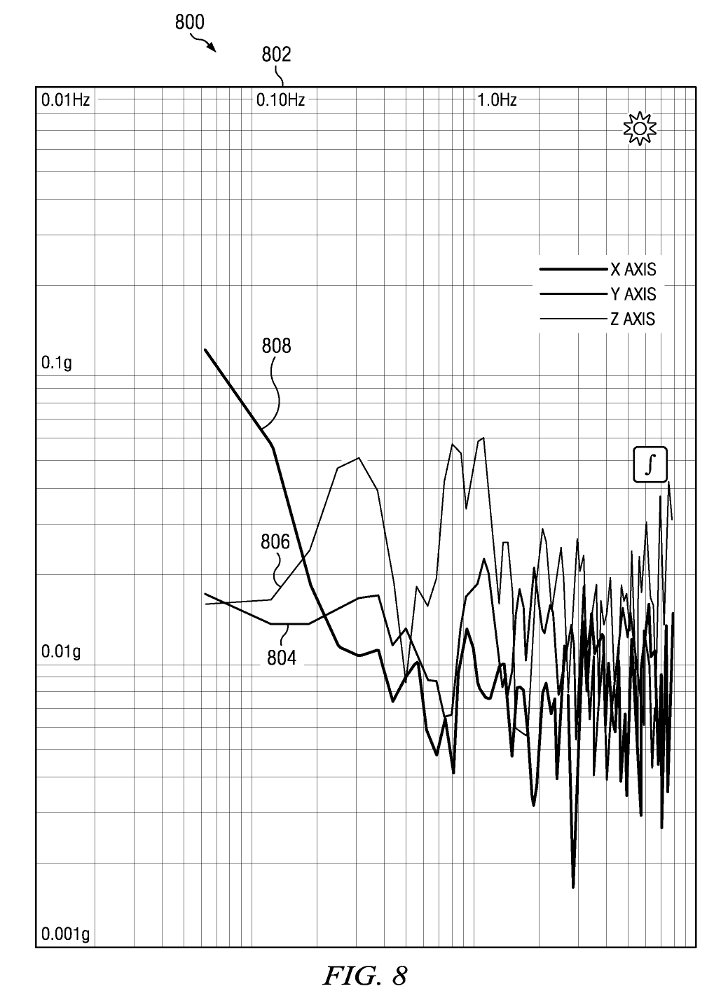

With reference now to FIG. 8, an illustration of turbulence information is depicted in accordance with an advantageous embodiment. In this illustrative example, turbulence information 800 may be displayed on display 802 of a data processing system. The data processing system may be, for example, handheld data processing system 218 in FIG. 2. Further, turbulence information 800 may be displayed when one of regions 704, 706, 708, 710, 712, 714, or 716 in FIG. 7 is selected.

In this illustrative example, turbulence information 800 is presented in the frequency domain. Turbulence information 800 is presented on three axes, as indicated by lines 804, 806, and 808. Line 804 is the x-axis, line 806 is the y-axis, and line 808 is the z-axis in these examples. The y-axis represents force in Gs, while the x-axis represents the frequency for the turbulence that is detected by a portable data processing system. The z-axis is along the velocity vector of the aircraft. In other words, the z-axis is in the direction in which the aircraft moves.

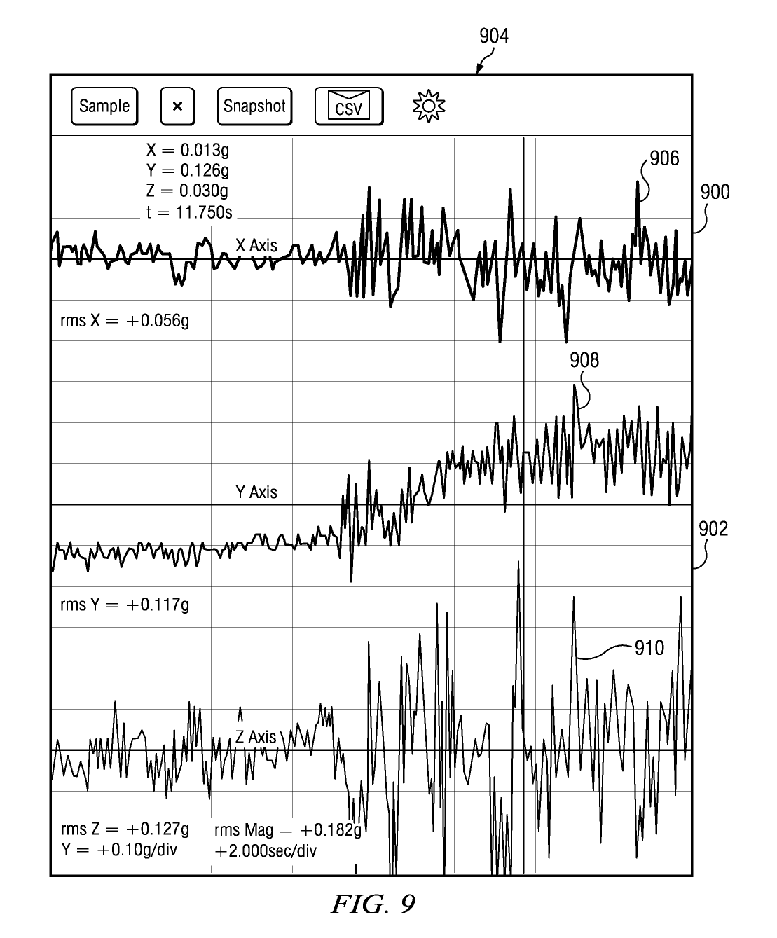

With reference now to FIG. 9, an illustration of turbulence information displayed on a data processing system is depicted in accordance with an advantageous embodiment.

In this illustrative example, turbulence information 900 is presented in the time domain. Turbulence information 900 is presented on display 902 of a data processing system. Turbulence information 900 may be an example of turbulence information 236 or processed turbulence information 264 in FIG. 2. In this illustrative example, display 902 may be a display generated by handheld data processing system 218 or remote data processing system 260 in FIG. 2.

In this illustrative example, turbulence information 900 includes pieces of data 904. Pieces of data 904 are illustrated in lines 906, 908, and 910. The x-axis represents time, while the y-axis represents magnitude. In this illustrative example, lines 906, 908, and 910 are separated into different axes. Line 906 indicates force on the x-axis, line 908 indicates force on the y-axis, while line 910 indicates force on the z-axis.

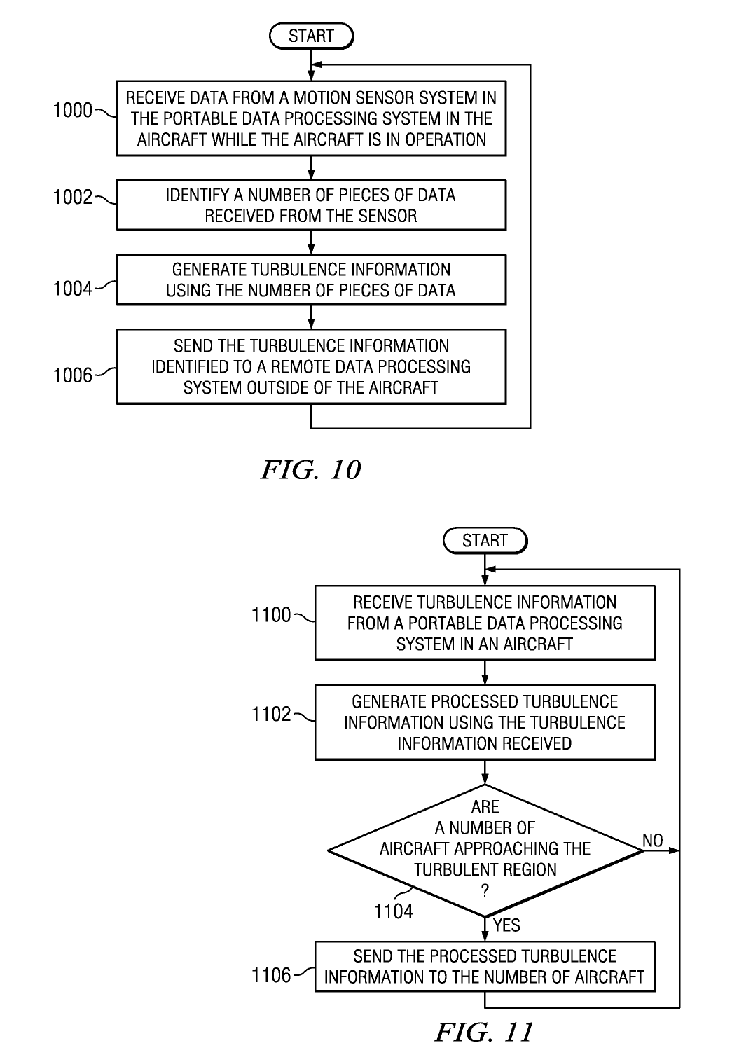

With reference now to FIG. 10, an illustration of a flowchart of a process for monitoring air turbulence is depicted in accordance with an advantageous embodiment. The process illustrated in FIG. 10 may be implemented in turbulence monitoring environment 100 in FIG. 1 and/or turbulence monitoring environment 200 in FIG. 2. In particular, the process may be implemented using portable data processing system 204 in aircraft 202 in FIG. 2.

The process begins by receiving data from a motion sensor system in the portable data processing system in the aircraft while the aircraft is in operation (operation 1000). In operation 1000, the portable data processing system is configured to be moved by a single person. For example, the portable data processing system may be handheld data processing system 218 in FIG. 2.

In these illustrative examples, the motion sensor system is comprised of a number of sensors that generate the data. The number of sensors may include, for example, without limitation, an accelerometer, a piezoresistor sensor, a strain gauge, and/or other suitable types of sensors.

The process then identifies a number of pieces of data in the data received from the sensor (operation 1002). The number of pieces indicates a presence of the turbulence encountered by the aircraft.

Thereafter, the process generates turbulence information using the number of pieces of data (operation 1004). The turbulence information may include the number of pieces of data, location information for the aircraft, time stamps, an aircraft identifier, and/or other suitable information. The time stamps indicate the time at which the number of pieces of data was generated.

The process then sends the turbulence information identified to a remote data processing system outside of the aircraft (operation 1006), with the process then returning to operation 1000 as described above. The remote data processing system may be located in an aircraft, a ground station, a transmitter and receiver station, or some other suitable location.

With reference now to FIG. 11, an illustration of a flowchart of a process for processing turbulence information is depicted in accordance with an advantageous embodiment. The process illustrated in FIG. 11 may be implemented in turbulence monitoring environment 100 in FIG. 1 and/or turbulence monitoring environment 200 in FIG. 2. In particular, the process may be implemented at ground station 118 in FIG. 1. Further, the process may be implemented using remote data processing system 256 in aircraft 202 in FIG. 2.

The process receives turbulence information from a portable data processing system in an aircraft (operation 1100). The portable data processing system may be, for example, portable data processing system 204 in FIG. 2. The process then generates processed turbulence information using the turbulence information received (operation 1102). The processed turbulence information may take the form of, for example, without limitation, processed turbulence information 500 in FIG. 5, processed turbulence information 600 in FIG. 6, and/or processed turbulence information 700 in FIG. 7.

In this illustrative example, the processed turbulence information may include a map identifying the location of the turbulent region and a magnitude of the turbulence in the turbulent region. Further, the processed turbulence information may include an indication of a period of time for which the turbulence may be present.

The process determines whether a number of aircraft are approaching the turbulent region (operation 1104). An aircraft may be approaching a turbulent region if the aircraft is entering the turbulent region or heading towards the turbulent region.

If a number of aircraft are approaching the turbulent region, the process then sends the processed turbulence information to the number of aircraft (operation 1106). In this manner, the number of aircraft may have the most current turbulence information for the turbulent region prior to reaching the turbulent region. The process then returns to operation 1100 as described above.

With reference again to operation 1104, if a number of aircraft are not approaching the turbulent region, the process then returns to operation 1100 as described above.

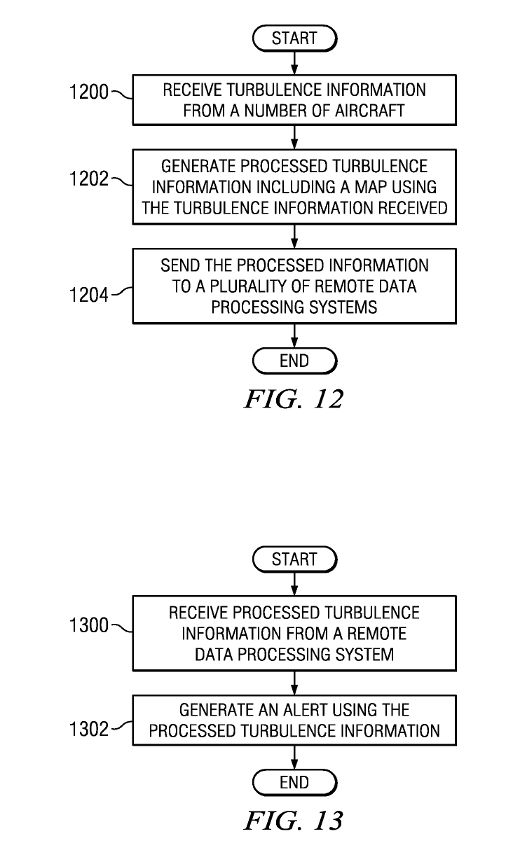

With reference now to FIG. 12, an illustration of a flowchart of a process for processing turbulence information is depicted in accordance with an advantageous embodiment. The process illustrated in FIG. 12 may be implemented in turbulence monitoring environment 100 in FIG. 1 and/or turbulence monitoring environment 200 in FIG. 2. In particular, the process may be implemented at ground station 118 in FIG. 1. Further, the process may be implemented using remote data processing system 256 in aircraft 202 in FIG. 2. The process begins by receiving turbulence information from a number of aircraft (operation 1200).

The turbulence information received may be for a number of turbulent regions. Thereafter, the process generates processed turbulence information including a map using the turbulence information received (operation 1202). The processed turbulence information including the map may take the form of, for example, a report.

In operation 1202, the processed turbulence information includes the map and an identification of the turbulent regions on the map. The processed turbulence information may include other information, such as, for example, an identification of the magnitude of the turbulence in the turbulent region, an identification of how long the turbulence may be encountered in a particular turbulent region, and/or other suitable information.

Thereafter, the process sends the processed information to a plurality of remote data processing systems (operation 1204), with the process terminating thereafter. The plurality of remote data processing systems may be associated with platforms including, for example, the number of aircraft, other aircraft, a number of air traffic control towers, and/or other platforms.

With reference now to FIG. 13, an illustration of a flowchart of a process for generating a turbulence alert is depicted in accordance with an advantageous embodiment. The process illustrated in FIG. 13 may be implemented in turbulence monitoring environment 100 in FIG. 1 and/or turbulence monitoring environment 200 in FIG. 2. In particular, the process may be implemented using handheld data processing system 122 in FIG. 1 and/or remote data processing system 260 in FIG. 2.

The process begins by receiving processed turbulence information from a remote data processing system (operation 1300). The remote data processing system may be, for example, ground station 118 in FIG. 1 and/or remote data processing system 256 in platform 258 in FIG. 2. The processed turbulence information may take the form of, for example, processed turbulence information 600 in FIG. 6 in this illustrative example.

Thereafter, the process generates an alert using the processed turbulence information (operation 1302), with the process terminating thereafter. In operation 1302, the alert may indicate to the operator of the aircraft that the aircraft may encounter turbulence during the flight.

The flowcharts and block diagrams in the different depicted embodiments illustrate the architecture, functionality, and operation of some possible implementations of apparatus and methods in different advantageous embodiments. In this regard, each block in the flowcharts or block diagrams may represent a module, segment, function, and/or a portion of an operation or step.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a portable data processing system comprising a portable housing configured to be moved by a single person; a processor unit associated with the portable housing; a motion sensor system associated with the portable housing, wherein the motion sensor system is configured to generate data about movement detected for the portable data processing system; a wireless communications unit associated with the portable data processing system; and a storage device; and
program code stored on the storage device, wherein the processor unit is configured to run the program code to receive the data from the motion sensor system, identify a number of pieces of data in the data received from the motion sensor system in which the number of pieces of data indicates a presence of turbulence encountered by an aircraft in which the portable data processing system is located, generate turbulence information using the number of pieces of data, and send the turbulence information identified to a remote data processing system outside of the aircraft.

2. The apparatus of claim 1 further comprising:
a wireless network in the aircraft, wherein the wireless network is configured to receive the turbulence information from the portable data processing system and send the turbulence information to the remote data processing system.

3. The apparatus of claim 2, wherein the wireless network comprises:
a router configured to receive the turbulence information from the portable data processing system and send the turbulence information to the remote data processing system.

4. The apparatus of claim 1, wherein the processor unit is configured to run the program code to include at least one of location information about the aircraft and time stamps in the turbulence information sent to the remote data processing system.

5. The apparatus of claim 4, wherein the processor unit is configured to receive the location information from a global positioning system unit.

6. The apparatus of claim 1, wherein in generating the turbulence information, the processor unit is configured to run the program code to determine whether a piece of data in the data generated by the motion sensor system exceeds a threshold and identify the piece of data as a piece of turbulence information in the turbulence information.

7. The apparatus of claim 1, wherein the motion sensor system is selected from at least one of an accelerometer, a piezoresistor sensor, and a strain gauge.

8. The apparatus of claim 1, wherein the remote data processing system is located in a second aircraft and the turbulence information comprises a time for which the turbulence is expected to be encountered by the second aircraft.

9. The apparatus of claim 1, wherein the remote data processing system is configured to receive the turbulence information from the portable data processing system and additional turbulence information from a number of other portable data processing systems in additional aircraft and generate a report using the turbulence information and the additional turbulence information.

10. The apparatus of claim 1, wherein the processor unit is further configured to run the program code to identify additional data during landing of the aircraft in which the additional data indicates the landing in which motion of the aircraft is greater than a threshold and send the additional data to the remote data processing system.

11. The apparatus of claim 1, wherein the data comprises acceleration values.

12. The apparatus of claim 1, wherein the turbulence information comprises at least one of the number of pieces of data, a value indicating a level of turbulence on a scale, a warning of when the turbulence is expected, an aircraft identifier, and a flight number.

13. A method for monitoring for turbulence, the method comprising:
receiving data from a motion sensor system in a portable data processing system in an aircraft while the aircraft is in operation, wherein the portable data processing system is configured to be moved by a single person;
identifying a number of pieces of data in the data received from the motion sensor system in which the number of pieces of data indicates a presence of the turbulence encountered;
generating turbulence information using the number of pieces of data; and
sending the turbulence information identified to a remote data processing system outside of the aircraft.

14. The method of claim 13, wherein the generating step comprises:
selecting the number of pieces of data from the data, wherein the number of pieces of data exceed a threshold and wherein each piece of data in the data exceeding the threshold is a piece of turbulence information in the turbulence information generated.

15. The method of claim 13 further comprising:
processing the turbulence information at the remote data processing system to generate processed turbulence information; and
sending the processed turbulence information to a number of other aircraft.

16. The method of claim 13 further comprising:
receiving additional turbulence information from a number of other portable data processing systems at the remote data processing system;
generating, by the remote data processing system, a report using the turbulence information and the additional turbulence information.

17. The method of claim 13, wherein the sending step comprises:
sending the turbulence information to a wireless network in the aircraft; and
sending, by the wireless network, the turbulence information to the remote data processing system outside of the aircraft.

18. The method of claim 13, wherein the turbulence information comprises at least one of the number of pieces of data, a value indicating a level of turbulence on a scale, a warning of when the turbulence is expected, an aircraft identifier, and a flight number.

19. A computer program product for monitoring turbulence, the computer program product comprising:
a computer recordable storage medium;
program code, stored on the computer recordable storage medium, for receiving data from a motion sensor system in a portable data processing system in an aircraft while the aircraft is in operation, wherein the portable data processing system is configured to be moved by a single person;
program code, stored on the computer recordable storage medium, for identifying a number of pieces of data in the data received from the motion sensor system in which the number of pieces of data indicates a presence of the turbulence encountered;
program code, stored on the computer recordable storage medium, for generating turbulence information using the number of pieces of data; and
program code, stored on the computer recordable storage medium, for sending the turbulence information identified to a remote data processing system outside of the aircraft.

20. The computer program product of claim 19, wherein the program code, stored on the computer recordable storage medium, for generating the turbulence information using the number of pieces of data comprises:
program code, stored on the computer recordable storage medium, for generating the turbulence information using the number of pieces of data selecting the number of pieces of data from the data, wherein the number of pieces of data exceed a threshold and wherein each piece of data in the data exceeding the threshold is a piece of turbulence information in the turbulence information generated.
